(19) United States
(12) Patent Application Publication
(10) Pub. No.: US 2008/0144126 A1
(43) Pub. Date: Jun. 19, 2008

(54) IMAGE PROCESSING APPARATUS, IMAGE PROCESSING METHOD, PROGRAM, AND STORAGE MEDIUM

(75) Inventor: Yukio Kanakubo, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/776,680

(22) Filed: Jul. 12, 2007

(30) Foreign Application Priority Data
Dec. 19, 2006 (JP) 2006-341130

(51) Int. Cl. H04N 1/32

(52) U.S. Cl. 358/468

(57) ABSTRACT

At least one exemplary embodiment is directed to an image processing apparatus configured to store moving image data including a plurality of continuously existing frames including at least a first frame and a second frame. The image processing apparatus detects a degree of clearness of an image included in the frame of the stored moving image data. Furthermore, the image processing apparatus compares a first image included in the first frame with a second image included in the second frame according to the detected degree of clearness. Moreover, the image processing apparatus selects a frame having a clearer image from among the first and the second frames according to a result of the comparison. In addition, the image processing apparatus extracts the selected frame as still image data and prints the extracted still image data.

### BACKGROUND OF THE INVENTION

1. Field of the Invention

The present invention relates to an image processing apparatus, an image processing method, a program, and an storage medium for performing processing to extract a frame included in moving image data as still image data.

2. Description of the Related Art

In recent years, as household digital video cameras become widely used, a consumer can easily utilize and enjoy various moving image data such as a high-quality TV picture in a High Resolution Digital Television (HDTV) and a plenty of moving image contents on the Internet. In addition, an inexpensive high image quality printers are widely used. Under these circumstances, in the video market, there is a demand that a scene in moving image data can be easily printed as a still image with a high image quality.

Conventionally, a scene in moving image data can be printed as a still image. In this regard, Japanese Patent Application Laid-Open No. 2005-229237 discusses a method in which, when moving image data is shot with a digital video camera, a print flag is added to an image frame arbitrarily designated by a user from among a plurality of image frames constituting the moving image data, so that the user can easily select and print the frame to which the print flag is attached, later.

In the method discussed by Japanese Patent Application Laid-Open No. 2005-229237, when selecting a frame which is to be provided with a flag, it is detected that a degree of image variation in continuous frames has reached a predetermined level, so that a flag can be added to the desired frame according to the detection result.

Furthermore, Japanese Patent Application Laid-Open No. 2005-197910 discusses a method in which the degree of camera shake is detected by a camera apparatus at the time of shooting and information indicating the detected degree of camera shake is recorded associated with each frame so that a frame little affected by camera shake can be identified and extracted according to the information about camera shake.

However, in shooting moving image, focusing adjustment on a subject can be frequently performed when the lens performs zooming and the shooting subject makes movement. Accordingly, when a specific scene in moving image data is extracted and printed as still image data, if the image in the selected frame has been shot during a focusing process, a defocused image can be printed. Moreover, a user can select an image having blur owing to movement of the subject.

As described above, a frame little affected by camera shake can be automatically selected using previously recorded information indicating the degree of camera shake during shooting associated with each frame. However, such information is not necessarily recorded with respect to all desired moving image data. Furthermore, such conventional method cannot be used in extracting still image data from moving image data taken with a device having no function for recording information which indicates the degree of camera shake.

Moreover, camera shake does not always occur during focusing. Therefore, it is very difficult or impossible to identify a frame taken during a focusing operation depending only on information indicating the degree of camera shake at the time of shooting. In addition, the conventional method cannot be used in the case where an image is blurred due to movement of a subject during shooting.

Accordingly, in the case of the conventional method, a user is required to perform a complicated operation. That is, the user has to closely check moving image data frame by frame to visually verify and search the content of an image in each frame. When a print frame is selected from long playing moving image data, or many frames have to be selected and printed, it is extremely inefficient to manually verify the content of images.

### SUMMARY OF THE INVENTION

The present invention is directed to an image processing apparatus, an image processing method, a program, and an storage medium for easily selecting a frame having a sharpest image from among a plurality of frames included in moving image data.

According to an aspect of the present invention, an image processing apparatus is provided which includes a memory unit configured to store moving image data that includes at least a first frame and a second frame; a detection unit configured to detect a degree of clearness of an image included in a frame of the moving image data stored on the memory unit; a comparison unit configured to compare a first image included in the first frame with a second image included in the second frame according to the degree of clearness detected by the detection unit; a selection unit configured to select a frame having a clearer image, from among the first frame and the second frame, according to a result of the comparison by the comparison unit; and an extraction unit configured to extract the frame selected by the selection unit as still image data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principle of the invention.

FIG. 1 illustrates a block diagram of an example multifunction peripheral (MFP) system according to a first exemplary embodiment of the present invention.

FIG. 2 illustrates an outline configuration of an example operation unit according to the first exemplary embodiment of the present invention.

FIG. 3 illustrates an example COPY basic screen displayed on the operation unit according to the first exemplary embodiment of the present invention.

FIG. 4 illustrates an example file list screen displayed on the operation unit according to the first exemplary embodiment of the present invention.

FIG. 5 illustrates an example structure of moving image data stored on a hard disk drive (HDD) according to the first exemplary embodiment of the present invention.

FIG. 6 illustrates time code information according to the first exemplary embodiment of the present invention.

FIG. 7 illustrates an example frame designation screen displayed on the operation unit according to the first exemplary embodiment of the present invention.

FIG. 8 illustrates an example frame determination screen displayed on an operation unit according to the first exemplary embodiment of the present invention.

FIG. 9 is a flowchart illustrating a series of example operations for identifying a frame having a most focused image from among a plurality of frames included in moving image data according to the first exemplary embodiment of the present invention.

FIG. 10 illustrates a block diagram of an example digital camera system according to a second exemplary embodiment of the present invention.

FIG. 11 is a flow chart illustrating a series of example operations for sending moving image data which includes a frame designated by a user for printing according to the second exemplary embodiment of the present invention.

FIG. 12 is a flow chart illustrating a series of example operations for receiving and printing the moving image data which includes a frame designated by a user for printing according to the second exemplary embodiment of the present invention.

FIG. 13 is a flow chart illustrating a series of example operations for comparing a focusing state considering scene change shown in frame images in the moving image data according to a third exemplary embodiment of the present invention.

FIG. 14 is a flow chart illustrating a series of example operations for comparing a focusing state considering a user's designation of an object according to a fourth exemplary embodiment of the present invention.

FIG. 15 illustrates an example object designation screen displayed on the operation unit according to the fourth exemplary embodiment of the present invention.

FIG. 16 illustrates an example area designating screen displayed on the operation unit according to a fifth exemplary embodiment of the present invention.

### DETAILED DESCRIPTION OF THE EXEMPLARY EMBODIMENTS

Various exemplary embodiments, features, and aspects of the present invention will now herein be described in detail with reference to the drawings. It is to be noted that the relative arrangement of the components, the numerical expressions, and numerical values set forth in these embodiments are not intended to limit the scope of the present invention unless it is specifically stated otherwise.

### First Exemplary Embodiment

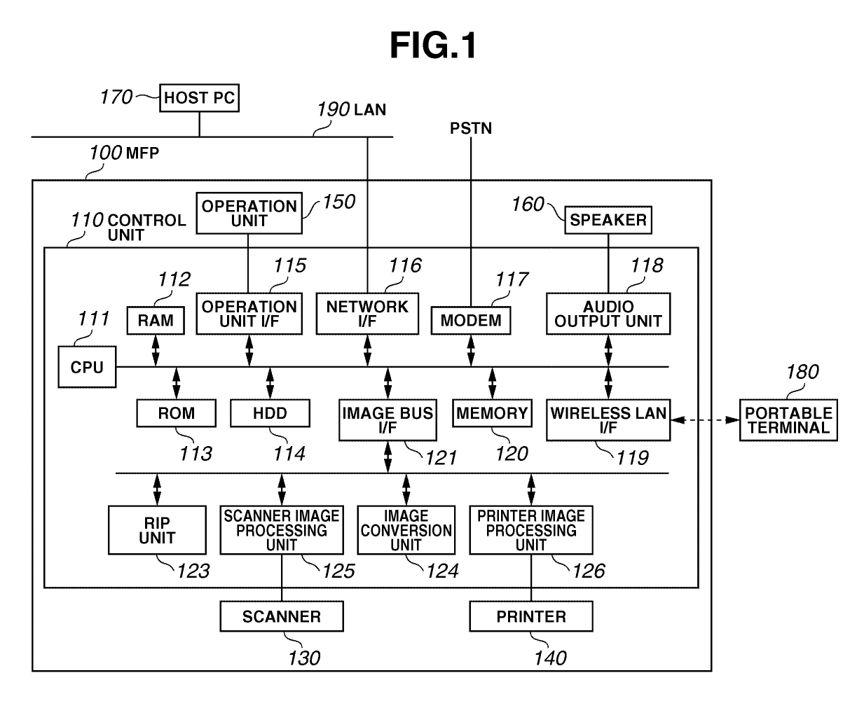

Now, a first exemplary embodiment of the present invention will be described below. FIG. 1 illustrates a block diagram of a multifunction peripheral (MFP) 100 system used as an image processing apparatus according to the first exemplary embodiment of the present invention.

Referring to FIG. 1, a control unit 110 is connected to an image input device and an image output device (such as a scanner 130 and a printer 140). The control unit 110 controls input and output of image information. The control unit 110 is connected to a local area network (LAN) 190 and a public switched telephone network (PSTN) (public line) and controls input and output of image information including moving image data or still image data and device information.

A central processing unit (CPU) 111 controls an operation of the MFP 100. The CPU 111 operates according to a program stored in a random access memory (RAM) 112. The RAM 112 is also an image memory for temporarily storing image data. A read only memory (ROM) 113 is a boot ROM that stores a system boot program.

A hard disk drive (HDD) 114 stores system software, image data, and a program for controlling the operation of the MFP 100. The CPU 111 reads the program stored on the HDD 114 and loads the read program onto the RAM 112 to control the operation of the MFP 100.

An operation unit interface (I/F) 115 is an interface between an operation unit 150 and the control unit 110. The operation unit I/F 115 outputs image data to be displayed on a screen of the operation unit 150. When a user inputs information via the operation unit 150, the operation unit I/F 115 sends the input information to the CPU 111.

A network I/F 116 is connected to the LAN 190 and controls input and output of various information. A modem 117 is connected to the PSTN and controls input and output of image information.

When moving image data and audio data stored on the HDD 114 are reproduced, an audio output unit 118 outputs audio information to a speaker 160. A wireless LAN I/F 119 performs wireless communication such as infrared-ray communication to exchange moving image data and still image data between the MFP 100 and a portable terminal 180 such as a cellular phone, a notebook type personal computer (PC), and a digital camera. The MFP 100 receives moving image data and still image data via the wireless LAN I/F 119 and stores the received moving image data and still image data in a user box in the HDD 114, which is described below.

A memory 120, just as the HDD 114, stores moving image data and still image data. The memory 120 can be a detachable external storage device.

An image bus I/F 121 controls input and output of image data via an image bus at a high speed. A raster image processor (RIP) unit 123 rasterizes a page description language (PDL) code received from a host PC 170 via the LAN 190 and the network I/F 116 into a bitmap image.

A scanner image processing unit 125 performs image correction on image data read from an original by the scanner 130. A printer image processing unit 126 performs image correction on image data to be output to the printer 140.

An image conversion unit 124 performs image conversion on image data stored on the RAM 112. More specifically, the image conversion unit 124 performs rotation processing and resolution conversion on an image. The image conversion unit 124 converts binary image data into multivalued image data and converts multivalued image data into binary image data.

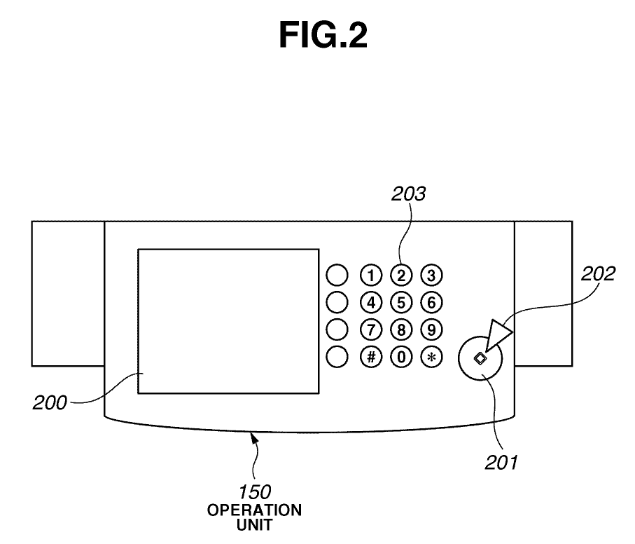

FIG. 2 illustrates an exemplary outline configuration of the operation unit 150 of the MFP 100. Referring to FIG. 2, a liquid crystal operation panel unit 200 is a liquid crystal display (LCD) device including a sheet-like touch panel unit. The liquid crystal operation panel unit 200 displays an operation screen for performing various settings and displays setting information input by a user on the operation screen.

The liquid crystal operation panel unit 200 reproduces and displays moving image data stored on the HDD 114 and displays a preview image of still image data stored on the HDD 114. When the user inputs an instruction via the touch panel, the liquid crystal operation panel unit 200 detects positional information of a portion that the user has touched. Then, the liquid crystal operation panel unit 200 transmits the content of the user instruction to the CPU 111 via the operation unit I/F 115.

A start key 201 is a hard key that enables a user to generate an instruction for starting a reading operation performed by the scanner 130 and a print operation performed by the printer 140. Green and red light emitting diodes (LEDs) are embedded inside the start key 201. The green LED illuminates when the MFP 100 is in an operable state. The red LED illuminates when the MFP 100 is in an inoperable state due to an error. A stop key 202 is a hard key that enables a user to generate an instruction for stopping an operation.

Hard keys 203 include numeric keypads, a reset key, and a user mode key. The numeric keypads enable a user to enter a numeric value such as a copy number. The reset key enables a user to reset all the performed settings. The user mode key enables a user to shift to a user mode to perform various device settings.

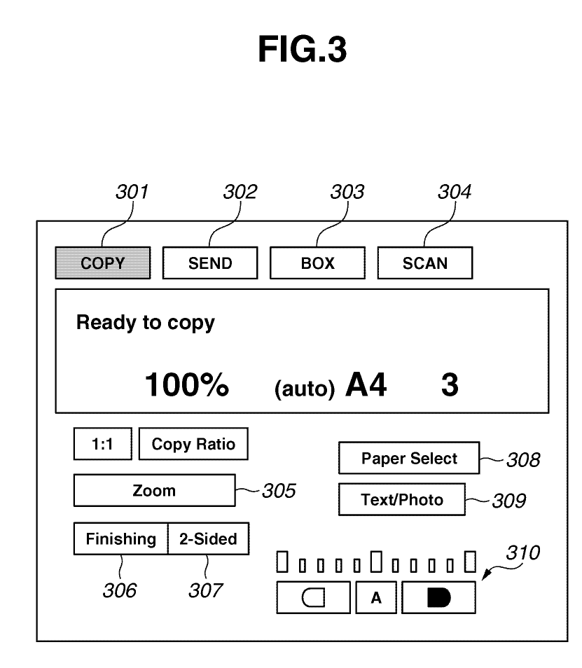

FIG. 3 illustrates an example of an operation screen displayed on the liquid crystal operation panel unit 200. The operation screen illustrated in FIG. 3 is a basic COPY screen displayed as a default screen when the MFP 100 is powered on. The MFP 100 includes four modes, that is, a COPY mode, a SEND mode, a BOX mode, and a SCAN mode, which are activated by a COPY button 301, SEND 302 button, BOX button 303, and SCAN button 304, respectively. The operation screen also includes a Zoom button 305, Finishing button 306, 2-Sided button 307, Paper Select 308, a Text/Photo button 309 and a darkness level selection button 310.

When the MFP 100 is in the COPY mode, the MFP 100 reads and inputs an image of an original using the scanner 130 and performs a copy operation for printing out the original using the printer 140. When the MFP 100 is in the SEND mode, the MFP 100 sends the image data input via the scanner 130 or the image data previously stored on the HDD 114 to a sending destination by an E-mail via the LAN 190 or the Internet.

When the MFP 100 is in the BOX mode, the MFP 100 processes (edits, prints, or transmits) various data stored in a box. Here, a “box” refers to a user box (storage area) on the HDD 114 which is allocated to each user.

When the MFP 100 is in the SCAN mode, the MFP 100 reads and inputs an image of an original using the scanner 130, stores the read (input) image data in the box, or sends the stored image data to the host PC 170 via the LAN 190.

The MFP 100 switches among the above-described modes when the user generates a mode shifting instruction via mode buttons 301 through 304. In FIG. 3, the COPY mode is selected. In this state, the user performs various settings. For example, the user performs a setting for magnification and reduction of the print target image data, selection as to a sheet discharge method, selection as to whether the image data is printed in one-sided printing or two-sided printing, selection as to a paper size, designation of text printing and photo printing, and designation of density.

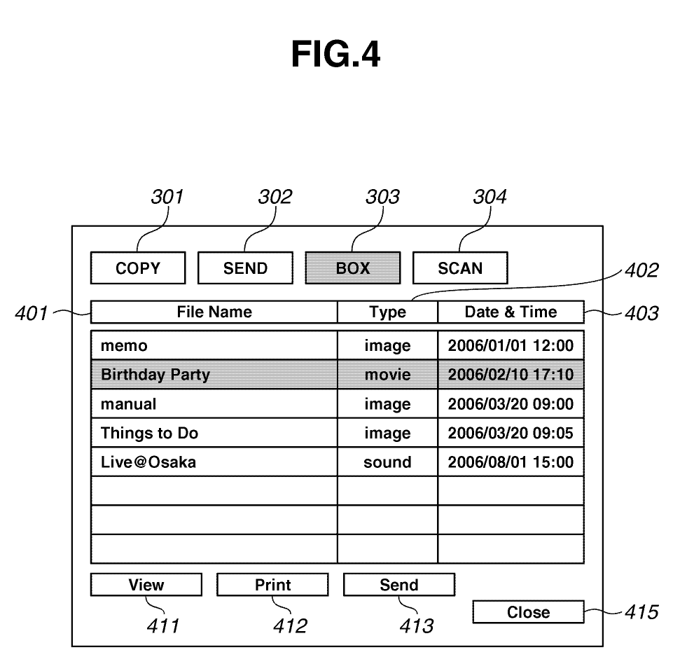

When the BOX mode button 303 illustrated in FIG. 3 is selected by a user, the liquid crystal operation panel unit 200 displays a user box list screen (not shown) in which user boxes allocated to each user and their respective attribute information are displayed as a list. When a user selects any one user box from the user box list displayed on the user box list screen, the liquid crystal operation panel unit 200 displays a file list screen illustrated in FIG. 4.

FIG. 4 illustrates an example of a file list screen for displaying attribute information of files stored in the user box which are selected via the user box list screen. A file name display field 401 displays a name of each file. A file type display field 402 displays information indicating a type of each file.

The HDD 114 can store moving image data (movie) and audio data (sound) as well as still image data (image). A storing date and time display field 403 displays information indicating a date and time on which each file is stored into a box.

When a user presses one of buttons 411 through 413 in a state where any one of the displayed files is selected, desired processing on the file stored in the user box starts. Unless at least one file is selected, a user cannot select the buttons 411 through 413. Also a “close” button 415 is also provided.

In selecting a file, a user touches a portion of the touch panel in which a name of a desired file is displayed. When one file is selected, a background of a portion in which attribute information of the selected file is displayed, changes to a different color to indicate that the file is selected.

In the example illustrated in FIG. 4, a moving image data file named “Birthday Party” is selected. The number of files that can be selected here is not limited to one, and a user can select a plurality of files at the same time. When a plurality of files are selected at the same time, a background of respective portions in which attribute information of each selected file is displayed, changes to a different color to indicate that the file is selected.

When a user selects the display button 411 in a state where a file is selected, the user can view and verify the content of the selected file. More specifically, in the case where the user has selected a still image data file, the liquid crystal operation panel unit 200 displays a preview image.

In the case where the user has selected an audio data file, the MFP 100 outputs the audio data from the speaker 160. In the case where the user has selected a moving image data file, the MFP 100 reproduces and displays the moving image data and outputs the audio data from the speaker 160. When a user has selected a plurality of files, the MFP 100 serially displays or reproduces the selected files in the order of selection.

When a user presses the print button 412 in a state where any file is selected, the MFP 100 prints the selected file with the printer 140. In the case where the user has selected a moving image data file, the MFP 100 selects a frame having an image to be printed from among a plurality of frames included in the selected moving image data file and prints the selected frame. The print processing will be described in detail below.

Since print processing cannot be performed on audio data, in the case where the user has selected an audio data file, the MFP 100 displays a warning message.

When a user selects the send button 413 in a state where any file is selected, the MFP 100 sends the selected file to a designated sending destination as an attachment of the E-mail. The MFP 100 can send not only still image data file but also a moving image data file and an audio data file. In the case where a user has selected a plurality of files, the MFP 100 attaches a plurality of files to one E-mail to send the selected files to a designated sending destination via E-mail.

When a user presses the print button 412 in a state where any file is selected, the MFP 100 prints the selected file with the printer 140. Here, when a user has selected a still image file, the MFP 100 performs the print processing according to print conditions entered via a print condition setting screen (not shown).

On the other hand, when a user has selected a moving image data file, the MFP 100 selects a frame having a print target image from among a plurality of frames included in the selected moving image data file, then extracts the image in the selected frame as still image data, and then prints the extracted still image data. Here, with respect to selection of a frame having the print target image, the MFP 100 according to the first exemplary embodiment includes a function for automatically selecting a sharpest image by comparing an image in a frame designated by a user with another frame positioned in the vicinity of the designated image.

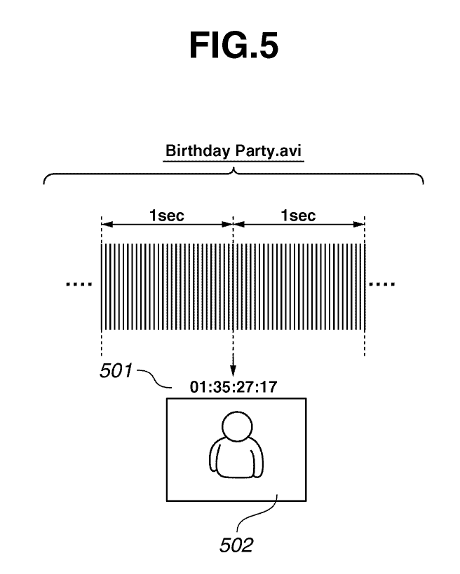

FIG. 5 illustrates an exemplary structure of moving image data including a plurality of frames. Referring to FIG. 5, with respect to moving image data file named “Birthday Party.avi” (“.avi” indicates a file identifier”), thirty frames are reproduced one after another in one second (that is, the frame rate is 30 frames per second (fps)). Accordingly, thirty frames are included in one second of the moving image data file named “Birthday Party.avi”.

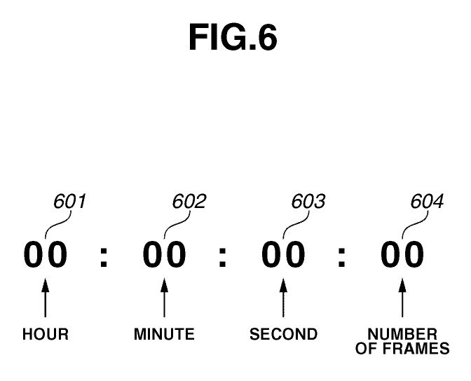

Time code information is added to each frame constituting moving image data according to time at which each frame is reproduced. FIG. 6 illustrates an example of time code information in detail.

Referring to FIG. 6, the time code information includes four portions, namely, an “hour” portion 601, a “minute” portion 602, a “second” portion 603, and a “frame number” portion 604, from left to right. The “frame number” portion 604 indicates each frame number from a top frame among the frames in specific one second. In the case of moving image data of 30 fps, a specific numerical value ranging from “1” to “30” is entered in the “frame number” portion 604.

For example, in the case of moving image data of precisely one hundred and twenty minutes, time code information “(00:00:01:01)” is added to a first frame and time code information “(02:00:00:30)” is added to a last frame.

As illustrated in FIG. 5, the moving image data file named “Birthday Party.avi” includes a frame 502 including time code information 501, “(01:35:27:17)”. In the first exemplary embodiment, a case where a user has designated the frame 502 as a frame to be extracted and printed as still image data, is described as an example.

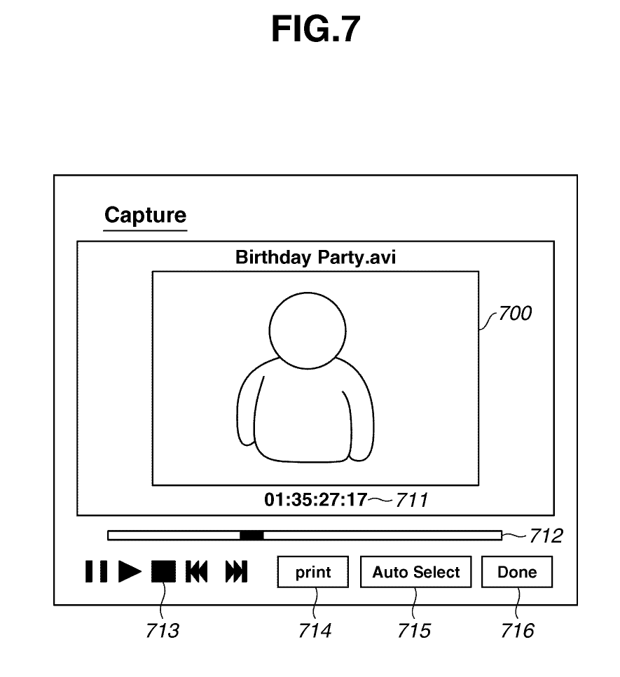

Returning to FIG. 4, when a user selects the print button 412 in a state where the moving image data file named “Birthday Party.avi” has been selected, a frame designation screen illustrated in FIG. 7 is displayed. Referring to FIG. 7, a moving image data display area 700 displays an image of each frame included in moving image data.

A time code information display area 711 displays time code information corresponding to the frame displayed in the moving image data display area 700. A seek bar 712 indicates a relative position of the frame displayed in the moving image data display area 700, in the entire moving image data.

A user can search an image in the frame which he desires to print by selecting any of buttons 713 to instruct reproduction, stopping, forwarding, rewinding, and frame advancing. To select a frame to be extracted and printed as still image data, a user pauses reproduction of the moving image data in a state where a desired frame is being displayed in the moving image data display area 700 and presses one of a print start button 714 and an auto select button 715.

The print start button 714 and the auto select button 715 are used as follows. The print start button 714 enables a user to print a designated frame without performing any selection processing. The auto select button 715 enables a user to perform printing by automatically selecting a frame having a sharpest image comparing a degree of clearness of the image designated by the user and images in the vicinity of the image designated by the user.

That is, when the user presses the auto select button 715 in a state where the frame 502 having a time code “01:35:27:17” is displayed in the moving image data display area 700, frames within 0.5 seconds previous and subsequent to the frame 502 are compared with the frame 502.

More specifically, the MFP 100 automatically selects a frame having a sharpest image from among frames having time codes “01:35:27:02” through “01:35:28:02”. The time length used for comparison (in this example, “0.5 seconds”) can be arbitrarily set in the user mode etc. by a user.

In the first exemplary embodiment, the degree of clearness of an image is determined by detecting a focusing state of an image and a most focused image is determined to be a sharpest image. A publicly known method can be used as a method for detecting the focusing state of an image.

For example, in a method discussed in Japanese Patent Application Laid-Open No. 2003-262909, the MFP 100 can detect a state of an edge portion of a subject to determine a focusing state based on sharpness, length, and direction of the detected edge.

Furthermore, the MFP 100 can detect a focusing state of an image according to luminance information of each image, using the method discussed in Japanese Patent Application Laid-Open No. 2005-148860. Any method other than the above-described methods can also be employed to determine a focusing state of an image. In addition, any methods other than determining a focusing state can also be employed as long as the degree of clearness of an image can be detected.

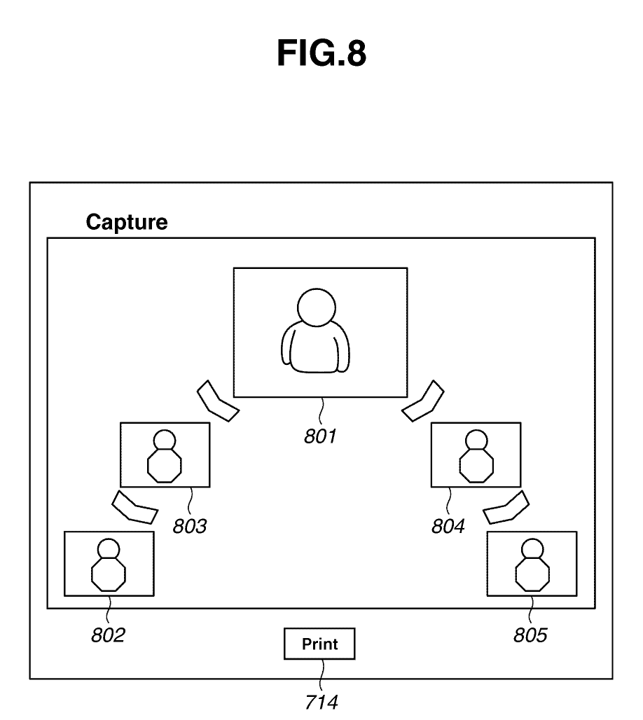

When a frame having a most focused (sharpest) image is identified from among images in fifteen frames previous and subsequent to the frame 502, a frame determination screen illustrated in FIG. 8 is displayed. In the first exemplary embodiment, after a frame having a sharpest (most focused) image is identified using the above-described method, successive images in a predetermined number of frames in the vicinity of the identified frame are displayed on the liquid crystal operation panel unit 200 as selection candidates.

Namely, even if an image has been identified as a most focused image, the identified image can have a layout not desired by the user, or the eyes of the subject can be closed in the image. In such a case, it is likely that the user does not desire to print the image. In order to address such a problem, in the present exemplary embodiment, images in other frames in the vicinity of the frame having the image determined to be most focused are displayed as selection candidates in addition to the most focused image.

Thus, a user can verify the contents of the automatically selected images and select a most appropriate frame.

FIG. 8 illustrates a frame determination screen in which the image in the frame determined to be the most focused, and images in previous two frames and subsequent two frames to the frame are displayed.

Referring to FIG. 8, a display area 801 displays the image determined to be most focused. Display areas 802 through 805 display images included in two frames previous and subsequent to the frame having the most focused image, as selection candidates.

When a user selects a desired image from among the images in the frames, which are displayed as thumbnail images on the frame determination screen, and presses the print start button 714, the frame selected from among the moving image data is extracted as still image data. Then, print image data is generated according to the extracted still image data. Then, the MFP 100 prints the image data with the printer 140.

However, the MFP 100 can also print the image determined to be most focused without displaying the selection candidates to allow the user to verify the content of the images.

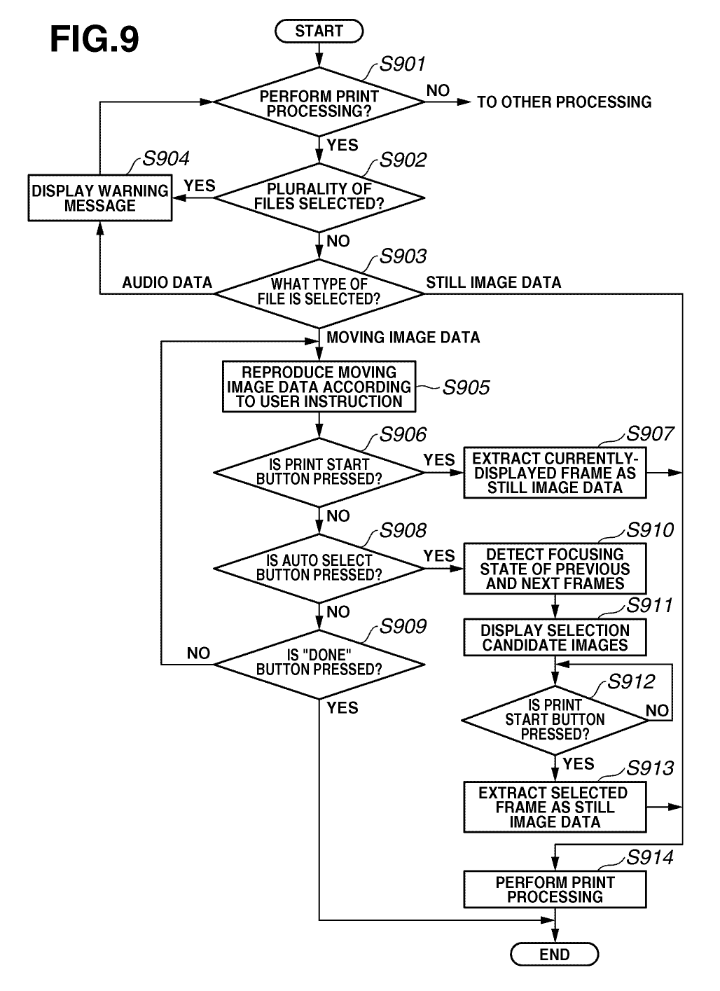

FIG. 9 is a flow chart precisely illustrating a series of operations for identifying a frame having a most focused image from among a plurality of frames included in moving image data to allow a user to select the frame having a most focused image. The series of operations illustrated in the flow chart in FIG. 9 is performed by the CPU 111 of the control unit 110 according to a program stored on the HDD 114.

Referring to FIG. 9, in step S901, the CPU 111 detects whether the user has pressed the print button 412. If it is detected in step S901 that the user has pressed the print button 412 (Yes in step S901), then the CPU 111 advances to step S902.

On the other hand, if it is detected in step S901 that the user has pressed a button other than the print button 412 (No in step S901), then the CPU 111 performs processing corresponding to the button that has been pressed.

In step S902, the CPU 111 detects whether a plurality of files has been selected via the file list screen illustrated in FIG. 4. If it is detected in step S902 that only one file has been selected via the file list screen illustrated in FIG. 4 (No in step S902), then the CPU 111 advances to step S903. In step S903, the CPU 111 detects which type of file has been selected.

If it is detected in step S903 that a moving image data file has been selected, then the CPU 111 advances to step S905. If it is detected in step S903 that a still image data file has been selected, then the CPU 111 advances to step S914.

If it is detected in step S902 that a plurality of files has been selected via the file list screen illustrated in FIG. 4 (Yes in step S902), or if it is detected in step S903 that an audio data file has been selected, then the CPU 111 advances to step S904. In step S904, the CPU 111 displays a warning, and then the CPU 111 returns to step S901.

In step S905, the CPU 111 displays the selected moving image data according to the instruction given from the user via the buttons 713. The user can reproduce, stop, pause, forward, rewind, or frame-advance the display of moving image data using the buttons 713. In step S906, the CPU 111 detects whether the user has pressed the print start button 714.

If it is detected in step S906 that the user has pressed the print start button 714 (Yes in step S906), then the CPU 111 advances to step S907. In step S907, the CPU 111 extracts the image displayed in the moving image data display area 700 as still image data.

On the other hand, if it is detected in step S906 that the user has not pressed the print start button 714 (No in step S906), then the CPU 111 advances to step S908. In step S908, the CPU 111 detects whether the user has pressed the auto select button 715. If it is detected in step S908 that the user has pressed the auto select button 715 (Yes in step S908), then the CPU 111 advances to step S910. In step S910, the CPU 111 detects a focusing state of fifteen frames previous and subsequent to the frame corresponding to the image displayed in the moving image data display area 700.

Furthermore, the CPU 111 identifies the frame having a most focused image from among the thirty frames which the CPU 111 compares with one another. In step S911, the CPU 111 displays thumbnail images of the identified frame and the images included in two frames previous and subsequent to the identified frame on the liquid crystal operation panel unit 200 as selection candidates.

In step S912, the CPU 111 detects whether the user has pressed the print start button 714 after selecting any of the images displayed as selection candidates. If it is detected that the user has pressed the print start button 714 (Yes in step S912), then the CPU 111 advances to step S913. In step S913, the CPU 111 extracts the selected image as still image data.

In step S914, the CPU 111 prints the still image data selected as print image data with the printer 140 according to the instruction for printing by the user.

If it is detected in step S908 that the user has not pressed the auto select button 715 (No in step S908), then the CPU 111 advances to step S909. In step S909, the CPU 111 detects whether the user has pressed a “done” button 716. If it is detected in step S909 that the user has pressed the “done” button 716 (Yes in step S909), then the CPU 111 ends the print processing.

On the other hand, if it is detected in step S909 that the user has not pressed the “done” button 716 (No in step S909), then the CPU 111 returns to step S905 to continue to reproduce, stop, forward, rewind and frame-advancing the display of the moving image data, and waits until the user presses either one of the print start button 714, the auto select button 715, and the “done” button 716.

According to the first exemplary embodiment, as described above, the MFP 100 detects the focusing state of an image in the frame designated by a user and images in the frames in the vicinity of the designated frame, and compares the images as to the focusing states according to the result of the detection to select a frame having a most focused image. Accordingly, a user is not required to perform a complicated operation to search a frame having a most focused image, which can improve user convenience.

In addition, together with the frame having a most focused image, images in the frames in the vicinity of the frame are displayed as selection candidates, which enables the user to select a print target image. Thus, the user can verify not only the image detected to be most focused but also the images taken prior to and subsequent to the most focused image, which can further improve user convenience.

### Second Exemplary Embodiment

Now, a second exemplary embodiment of the present invention will be described below. In the first exemplary embodiment, a user designates a frame from among a plurality of frames included in moving image data stored on the HDD 114 of the MFP 100, and the MFP 100 detects the focusing state of the images using the designated frame as a reference frame.

In the second exemplary embodiment, a user operates a portable terminal to designate a frame from among a plurality of frames included in moving image data stored in the portable terminal. The MFP 100 receives information for identifying the designated frame and the moving image data stored in the portable terminal, and detects a focusing state using the designated frame as a reference frame. Then, the MFP 100 extracts and prints the frame having a most focused image as still image data.

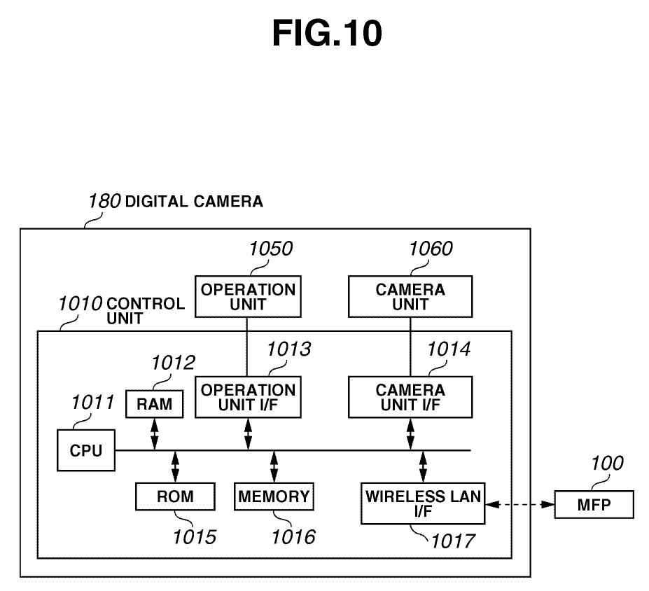

In the second exemplary embodiment, a digital camera is used as an example of the portable terminal 180. FIG. 10 illustrates an exemplary configuration of a portable terminal system 180. A control unit 1010 is connected with an operation unit 1050 and a camera unit 1060, and controls input and output of various information.

A CPU 1011 controls the operation of the portable terminal 180. The CPU 1011 operates according to a program stored in a RAM 1012. The RAM 1012 serves also as an image memory for temporarily storing image data.

A ROM 1015 is a boot ROM that stores a system boot program. A memory 1016 stores system software, image data, and a program for controlling the operation of the portable terminal 180. The CPU 1011 reads the program stored on the memory 1016 and loads the read program on the RAM 1012 to control the operation of the portable terminal 180.

An operation unit I/F 1013 is an interface between the operation unit 1050 and the control unit 1010. The operation unit I/F 1013 outputs image data to be displayed on a screen of the operation unit 1050. When a user inputs information via the operation unit 1050, the operation unit I/F 1013 sends the input information to the CPU 1011.

The camera unit 1060 includes an image taking function. Still image data or moving image data shot by the camera unit 1060 is input to the control unit 1010 via a camera unit I/F 1014. A wireless LAN I/F 1017 performs wireless communication such as infrared-ray communication to send moving image data and still image data to the MFP 100.

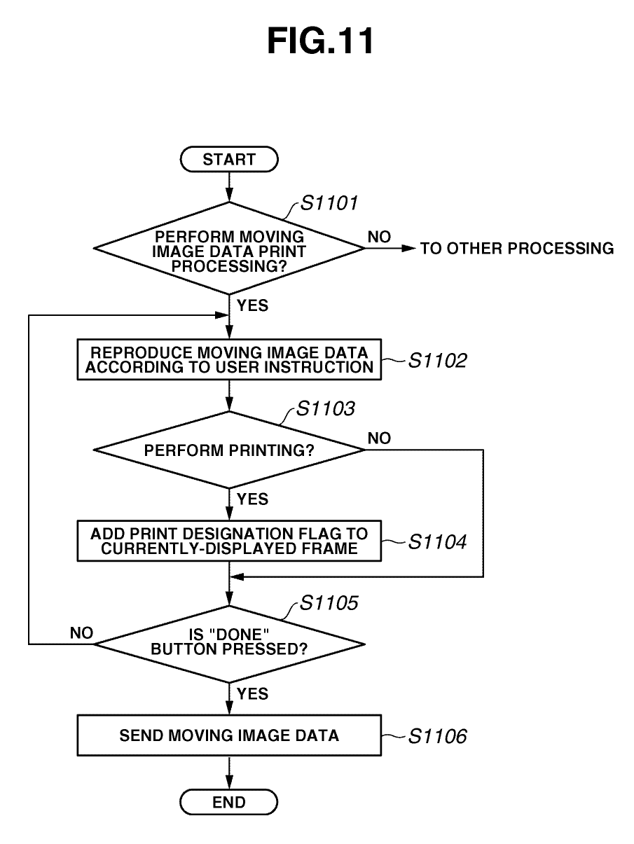

FIG. 11 is a flow chart illustrating a series of operations performed by the portable terminal 180 for sending moving image data taken by the camera unit 1060 to the MFP 100, whose frame is designated by a user. The control of the series of operations illustrated in the flow chart in FIG. 11 is performed by the CPU 1011 of the control unit 1010 according to a program stored in the memory 1016.

Referring to FIG. 11, in step S1101, the CPU 1011 detects whether the user has selected a mode for printing the moving image data. If it is detected in step S1101 that the user has selected a mode for printing the moving image data (Yes in step S1101), then the CPU 1011 advances to step S1102. On the other hand, if it is detected in step S1011 that the user has not selected a mode for printing the moving image data (No in step S1101), then the CPU 1011 performs processing according to the instruction from the user.

In step S1102, the CPU 1011 displays the selected moving image data according to the instruction from the user. Here, the user can reproduce, stop, pause, forward, rewind, or frame-advance the display of moving image data. In step S1103, the CPU 1011 detects whether the user has issued an instruction for printing the moving image data.

If it is detected in step S1103 that the user has issued an instruction for printing the moving image data (Yes in step S1103), then the CPU 1011 advances to step S1104. In step S1104, the CPU 1011 adds a print designation flag to the frame corresponding to the image displayed on the operation unit 1050.

If it is detected in step S1103 that the user has not issued an instruction to print the moving image data (No in step S1101), or after the CPU 1011 adds a print designation flag to the frame corresponding to the image displayed on the operation unit 1050, then the CPU 1011 advances to step S1105. In step S1105, the CPU 1011 detects whether the user has issued an instruction to terminate the moving image data print. If it is detected in step S1105 that the user has not issued an instruction to terminate the moving image data print (No in step S1105), then the CPU 1011 returns to step S1102.

On the other hand, if it is detected in step S1105 that the user has issued an instruction to terminate the moving image data print (Yes in step S1105), then the CPU 1011 advances to step S1106. In step S1106, the CPU 1011 sends the moving image data including the frame with the print designation flag, and then ends the processing.

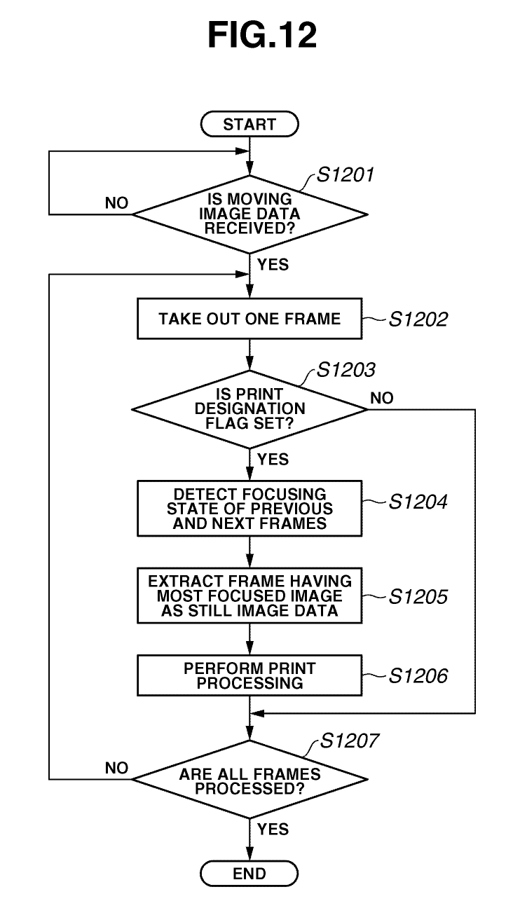

FIG. 12 is a flow chart illustrating a series of operations performed by the MFP 100 for extracting and printing any of a plurality of frames included in the moving image data received from the portable terminal 180. The series of operations illustrated in the flow chart in FIG. 12 is performed by the CPU 111 of the control unit 110 according to a program stored on the HDD 114.

Referring to FIG. 12, in step S1201, the CPU 111 detects whether the MFP 100 has received moving image data from the portable terminal 180. If it is detected in step S1201 that the MFP 100 has received moving image data from the portable terminal 180 (Yes in step S1201), then the CPU 111 advances to step S1202. In step S1202, the CPU 111 extracts one frame from a plurality of frames included in the received moving image data. In step S1203, the CPU 111 detects whether a print designation flag is added to the extracted frame.

If it is detected in step S1203 that a print designation flag is added to the extracted frame (Yes in step S1203), then the CPU 111 advances to step S1204. In step S1204, the CPU 111 detects the focusing state of the image in the extracted frame and the images in the frames existing around the extracted frame, and compares the images as to their focusing state. In step S1205, the CPU 111 extracts the frame having a most focused image from among the compared images, as still image data.

The above-described processing for comparing the images in the frames based on the focusing state of the images and selecting a frame having a most focused image is similar to the processing described in the first exemplary embodiment.

In step S1206, the CPU 111 prints the still image data extracted in step S1205 with the printer 140. In step S1207, the CPU 111 detects whether all the frames in the received moving image data have been processed. If it is detected in step S1207 that an unprocessed frame still remains (No in step S1207), then the CPU 111 returns to step S1202.

On the other hand, if it is detected in step S1207 that all the frames in the received moving image data have been processed (Yes in step S 1207), then the CPU 111 ends the processing.

In the second exemplary embodiment, as described above, when the MFP 100 receives moving image data from an external terminal (digital camera) in which a user has designated a print frame, the MFP 100 can automatically select a frame having a most focused image and print the selected frame.

It is useful that a user can designate in the digital camera whether the auto selection processing is to be performed by the MFP 100. Furthermore, the external terminal is not limited to a digital camera and can be a notebook PC having no camera function.

In addition, it is useful that the digital camera can perform the processing for detecting the focusing state of the images in the frames and comparing the images. In this case, the CPU 1011 of the portable terminal 180 sends only the image detected to be most focused to the MFP 100.

### Third Exemplary Embodiment

Now, a third exemplary embodiment will be described below. In the first exemplary embodiment, the CPU 111 of the MFP 100 detects the focusing states of the images in the frames within 0.5 seconds previous and subsequent to a frame designated by a user.

In the third exemplary embodiment, the MFP 100 further includes a function for detecting change of scenes in images of frames included in moving image data. With this function, the MFP 100 selects a most focused image from among images showing the same scene as the image designated by the user.

In the first exemplary embodiment, the images in the frames existing within a predetermined length of time from the reference frame are compared with one another. In this case, an image completely different from the image designated by the user can be selected as a most focused image. In such a case, although the selected image is most focused among the compared images, the selected image is not the image which the user desires to print. It is useless to print the selected image in this case.

In the third exemplary embodiment, an image showing the same scene as the image designated by the user is compared as to a focusing state. Thus, the MFP 100 can automatically select a most focused image from among the images similar to the one desired by the user for printing.

A publicly known method is used as the method for detecting the scene change in images of frames included in moving image data. That is, as discussed in Japanese Patent Application Laid-Open No. 2004-361988, a characteristic amount of an image in each frame is extracted, and each extracted amount of successive frames is compared with one another.

The change of scenes can be detected by recognizing a characteristic extracted from a specific object (e.g., a face of a person) in an image. The method for detecting the scene change in moving image data is not limited to the above-described, and other methods can also be used.

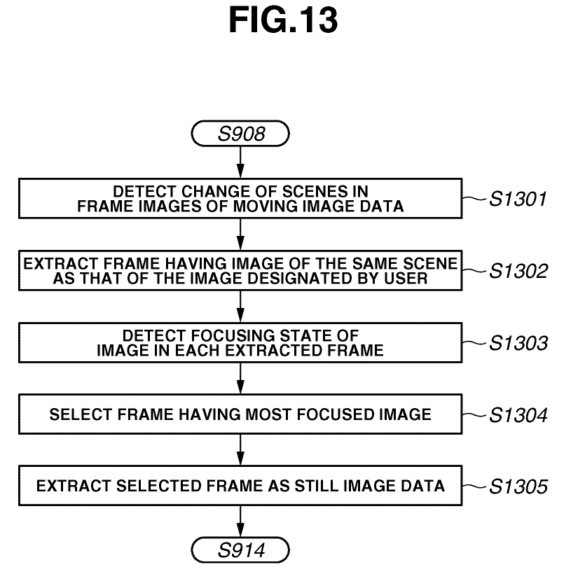

FIG. 13 is a flow chart illustrating a series of operations for automatically selecting a frame having a most focused image from among frames having images showing the same scene as the image designated by the user. The processing illustrated in the flow chart in FIG. 13 corresponds to the processing in steps S910 through S913 illustrated in the flow chart of FIG. 9.

The series of operations illustrated in the flow chart in FIG. 13 is performed by the CPU 111 of the control unit 110 according to a program stored on the HDD 114.

Referring to FIG. 13, in step S1301, the CPU 111 detects a position at which the scene changes in images of the frames included in the moving image data, by the above-described method. In step S1302, the CPU 111 extracts a frame having an image showing the same scene as the image of the frame designated by the user in step S909.

In step S1303, the CPU 111 detects the focusing state of the images in the frames extracted in step S1302 and compares the extracted images as to the focusing state. In step S1304, the CPU 111 selects a frame having a most focused image from among the compared frames. In step S1305, the CPU 111 extracts the selected frame as still image data, and then advances to step S914.

As described above, in the third exemplary embodiment, the CPU 111 extracts the frames to be compared, according to the scene change in the images of the frames included in the moving image data. Thus, a frame having a most focused image can be selected from among the frames having an image desired by the user.

### Fourth Exemplary Embodiment

Now, a fourth exemplary embodiment of the present invention will be described below. In the first exemplary embodiment, the CPU 111 performs the detection on images in the frames of 0.5 seconds previous and subsequent to a frame designated by the user as to their focusing states.

In the fourth exemplary embodiment, the CPU 111 receives designation of a frame from a user as well as designation of an object from among objects included in the image of the frame designated by the user, to select a most focused image from among the images including the designated objects.

In the first exemplary embodiment, the images in the frames existing within a predetermined length of time from the reference frame are compared with one another. In this case, an image completely different from the image designated by the user can be selected as a most focused image. In such a case, although the selected image is most focused among the compared images, the selected image is not the image desired by the user for printing. Accordingly, it is useless to print the selected image in this case.

In the fourth exemplary embodiment, images showing the object designated by the user are compared as to their focusing state. Thus, the MFP 100 can automatically select a most focused image from among the images similar to the image desired by the user for printing.

When the user selects an object shown in an image in a frame included in moving image data, the frame showing the selected object can be extracted as follows.

That is, each object is identified by dividing the image into areas according to the characteristic amount extracted from the image designated by the user. Then, the CPU 111 receives designation of an object from the user performed via an object selection screen on which each of the identified objects is displayed.

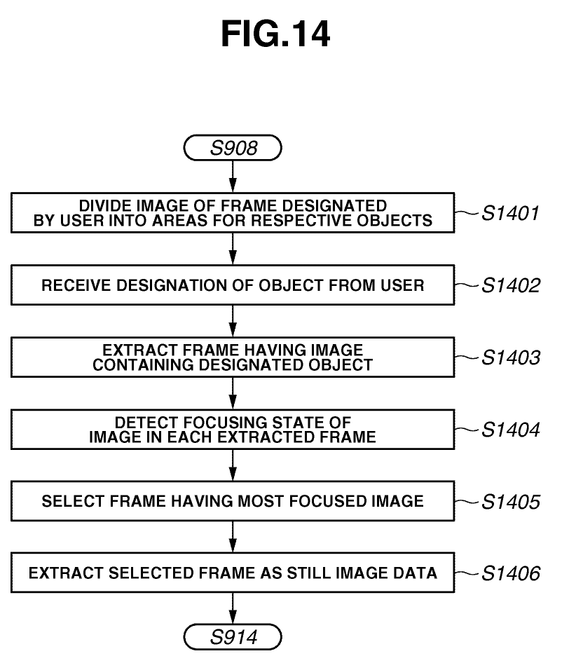

FIG. 14 is a flow chart illustrating a series of operations for automatically selecting a frame having a most focused image from among frames having an image showing the object designated by the user. The processing illustrated in the flow chart of FIG. 14 corresponds to the processing in steps S910 through S913 illustrated in the flow chart of FIG. 9.

The series of operations illustrated in the flow chart of FIG. 13 is performed by the CPU 111 of the control unit 110 according to a program stored on the HDD 114.

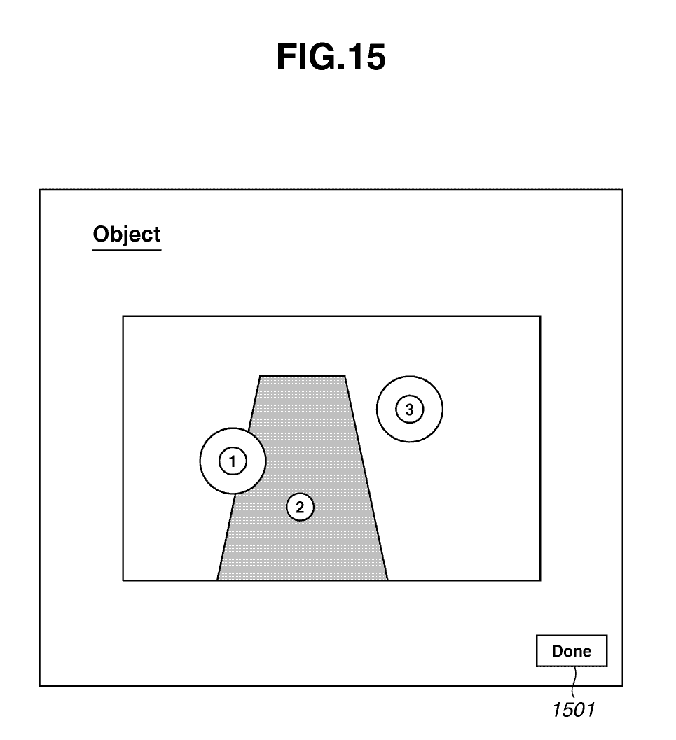

Referring to FIG. 14, in step S1401, the CPU 111 divides the image in the frame designated by the user into respective areas using the above-described method to identify each object. In step S1402, the CPU 111 receives a designation of an object from the user, performed via a screen shown in FIG. 15. FIG. 15 illustrates an example object designation screen displayed on the operation unit according to the fourth exemplary embodiment of the present invention. The aforementioned screen can be closed via the “Done” button 1501.

In step S1403, the CPU 111 extracts a frame having an image showing the object designated by the user in step S1402.

In step S1404, the CPU 111 detects the focusing state of each image in the frames extracted in step S1403 and compares the extracted images as to the focusing state. In step S1405, the CPU 111 selects a frame having a most focused image from among the compared frames. In step S1406, the CPU 111 extracts the selected frame as still image data, and then advances to step S914.

As described above, in the fourth exemplary embodiment, the CPU 111 extracts the frames having images showing the object designated by the user.

Thus, a frame having a most focused image can be selected from among the frames having an image desired by the user.

### Fifth Exemplary Embodiment

Now, a fifth exemplary embodiment of the present invention will be described below. In the first through the fourth exemplary embodiment, the CPU 111 performs detection of the focusing state of images on all the frames to be compared and compares the images according to the detected focusing states.

In such a case, if a very large number of frames are to be compared, a great amount of processing load is applied on the CPU 111 so that it takes a long time to complete the processing. In the fifth exemplary embodiment, the CPU 111 performs the processing for detecting the focusing state and comparing the images as to their focusing states in two different stages, as described below.

As a first stage of the processing, the CPU 111 extracts one frame at a predetermined time interval from among frames to be compared. Then, the CPU 111 detects the focusing state of the images in the extracted frames and compares the images in the frames as to the focusing state to select a frame having a most focused image.

In a second stage of the processing, the CPU 111 detects the focusing state of the images in the frames within the predetermined time length from the frame selected in the above-described first stage and compares the images as to the focusing state to select a frame having a most focused image. Then, the CPU 111 extracts the selected frame as still image data and prints the extracted still image data.

In the fifth exemplary embodiment, as described above, it is not necessary to perform the detection of the focusing state and the comparison of the images as to the focusing state on all the images in the frames to be compared. Accordingly, the load applied on the CPU 111 can be reduced.

### Sixth Exemplary Embodiment

Now, a sixth exemplary embodiment will be described below. In the first exemplary embodiment, the CPU 111 detects the focusing state of the entire portion of each image in the frames included in the moving image data.

In the sixth exemplary embodiment, the user can designate an area to be detected as to the focusing state, from among image areas in each of the frames.

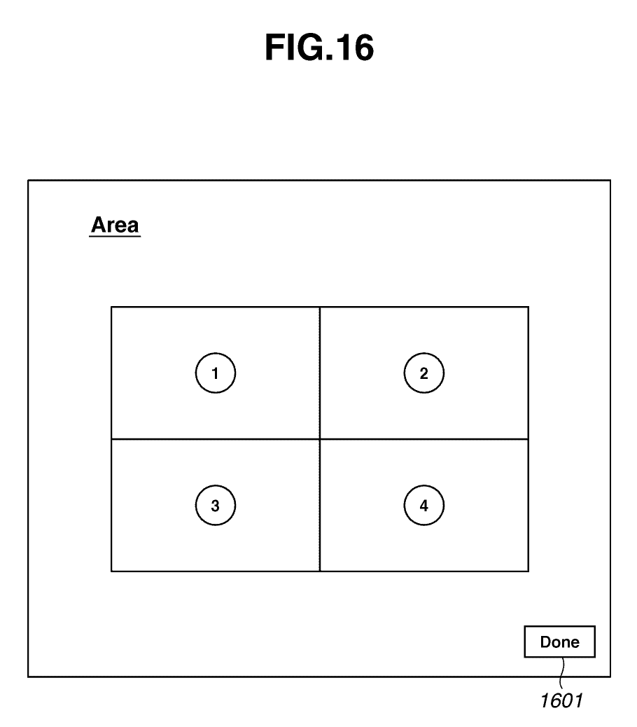

The user previously designates an area to be detected as to the focusing state in the user mode of the MFP 100 via an area designation screen illustrated in FIG. 16. In the example illustrated in FIG. 16, the user selects an area from four image areas.

After the user designates an area, when the detection is performed as to the focusing state according to the processing illustrated in above-described flow charts, the CPU 111 performs the detection as to the focusing state with respect to the area designated by the user. The aforementioned screen can be closed via the “Done” button 1601.

The method for dividing the image into areas is not limited to the method illustrated in the example in FIG. 16. A user can designate an area of an arbitrary size. In addition, the method for designating an area does not have to be performed in the user mode. That is, the user can perform the designation of an image area each time moving image data is printed.

Each of the functions described in the above-described first through the sixth exemplary embodiments can be implemented as a single independent function or can be implemented as a combination thereof.

### Other Exemplary Embodiments

The present invention can be implemented, for example, in a system, an apparatus, a method, a program, or a storage medium (recording medium). More specifically, the present invention can be applied to a system including a plurality of devices or can be applied to an apparatus including one device.

The present invention can be implemented by directly or remotely supplying a program of software implementing functions of the above-described exemplary embodiments (the program corresponding to the flow charts in the drawings in the case of the exemplary embodiments) to a system or an apparatus, and reading and executing supplied program codes by a computer of the system or the apparatus.

Accordingly, the program code itself, which is installed to the computer for implementing the functional processing of the present invention by the computer, implements the present invention. That is, the present invention also includes the computer program implementing the functional processing of the present invention.

Accordingly, the program can be configured in any form, such as object code, a program executed by an interpreter, and script data supplied to an OS.

As the recording medium for supplying such program code, for example, a floppy disk, a hard disk, an optical disk, a magneto-optical disk (MO), a compact disk read only memory (CD-ROM), a compact disk recordable (CD-R), a compact disk rewritable (CD-RW), a magnetic tape, a nonvolatile memory card, a ROM, and a digital versatile disk (DVD) (a DVD read only memory (DVD-ROM) and a DVD recordable (DVD-R)) can be used.

The above program can also be supplied by connecting to a web site on the Internet by using a browser of a client computer and by downloading the program from the web site to a recording medium such as a hard disk. In addition, the above program can also be supplied by downloading a compressed file that includes an automatic installation function from the web site to a recording medium such as a hard disk. The functions of the above embodiments can also be implemented by dividing the program code into a plurality of files and downloading each divided file from different web sites. That is, a WWW server for allowing a plurality of users to download the program file for implementing the functional processing constitutes the present invention.

In addition, the above program can also be supplied by distributing a storage medium such as a CD-ROM and the like which stores the program according to the present invention after performing an encryption. Then, the user who is qualified for a prescribed condition can download key information for decoding the encryption from the web site via the Internet so that the encrypted program code can be installed and executed by the computer using the key information.

In addition, the functions according to the embodiments described above can be implemented not only by executing the program code read by the computer, but can also be implemented by the processing in which an OS (operating system) or the like carries out a part of or the whole of the actual processing based on an instruction given by the program code.

Further, in another aspect of the embodiment of the present invention, after the program code read from the recording medium is written in a memory provided in a function expansion board inserted in a computer or a function expansion unit connected to the computer, a CPU and the like provided in the function expansion board or the function expansion unit carries out a part of or the whole of the processing to implement the functions of the embodiments described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-341130 filed Dec. 19, 2006, which is hereby incorporated by reference herein in its entirety.

What is claimed is:

1. An image processing apparatus comprising:
a memory unit configured to store moving image data that includes at least a first frame and a second frame;
a detection unit configured to detect a degree of clearness of an image included in a frame of the moving image data stored on the memory unit;
a comparison unit configured to compare a first image included in the first frame with a second image included in the second frame according to the degree of clearness detected by the detection unit;
a selection unit configured to select a frame having a clearer image, from among the first frame and the second frame, according to a result of the comparison by the comparison unit; and
an extraction unit configured to extract the frame selected by the selection unit as still image data.

2. The image processing apparatus according to claim 1, wherein the detection unit recognizes a focusing state of the image and identify a more focused image as the clearer image.

3. The image processing apparatus according to claim 2, wherein the detection unit detects an edge in a boundary portion of an object included in the image and recognizes a focusing state of the image according to a state of the detected edge.

4. The image processing apparatus according to claim 1, further comprising a printing unit configured to print the still image data extracted by the extraction unit.

5. The image processing apparatus according to claim 1, further comprising:
a frame designation unit configured to designate a frame, from among a plurality of frames included in the moving image data, as the first frame; and
a first identification unit configured to identify a frame that exists within a predetermined time length from the frame designated by the frame designation unit as the second frame.

6. The image processing apparatus according to claim 1, further comprising:
a frame designation unit configured to designate a frame, from among a plurality of frames included in the moving image data, as the first frame; and
a second identification unit configured to identify a frame as the second frame that includes an image similar to an image included in the frame designated by the frame designation unit.

7. The image processing apparatus according to claim 1, further comprising:
a frame designation unit configured to designate a frame, from among a plurality of frames included in the moving image data, as the first frame;
an object designation unit configured to designate an object from among a plurality of objects included in the image in the frame designated by the frame designation unit; and
a third identification unit configured to identify a frame as the second frame that includes an image having the same object as the object designated by the object designation unit.

8. The image processing apparatus according to claim 1, further comprising an area designation unit configured to designate an area of the image to be subjected to the detection by the detection unit, wherein the detection unit detects the degree of clearness of the image in the designated area.

9. The image processing apparatus according to claim 1, further comprising a display unit configured to display at least one frame different than the frame selected by the selection unit and existing within a predetermined time length from the selected frame, as a candidate of a frame to be extracted by the extraction unit.

10. A method in an image processing apparatus, the method comprising:
storing moving image data that includes at least a first frame and a second frame;
detecting a degree of clearness of an image included in a frame of the stored moving image data;
comparing a first image included in the first frame with a second image included in the second frame according to the detected degree of clearness;
selecting a frame having a clearer image, from among the first frame and the second frame, according to a result of the comparison; and
extracting the frame selected by the selection as still image data.

11. The method according to claim 10, further comprising identifying a more focused image as a clearer image by recognizing a focusing state of the image.

12. The method according to claim 11, further comprising detecting an edge in a boundary portion of an object included in the image to recognize a focusing state of the image according to a state of the detected edge.

13. The method according to claim 10, further comprising printing the extracted still image data.

14. The method according to claim 10, further comprising:
designating a frame, from among a plurality of frames included in the moving image data, as the first frame; and
identifying a frame that exists within a predetermined time length from the designated frame as the second frame.

15. The method according to claim 10, further comprising:
designating a frame, from among a plurality of frames included in the moving image data, as the first frame; and
identifying a frame as the second frame that includes an image similar to an image included in the designated frame.

16. The method according to claim 10, further comprising:
designating a frame, from among a plurality of frames included in the moving image data, as the first frame;
designating an object from among a plurality of objects included in the image in the designated frame; and
identifying a frame as the second frame that includes an image having the same object as the designated object.

17. The method according to claim 10, further comprising:
designating an area of the image to be subjected to the detection, and
detecting the degree of clearness of the designated area of the image.

18. The method according to claim 10, further comprising displaying at least one frame different than the selected frame and existing within a predetermined time length from the selected frame, as a candidate of a frame to be extracted.

19. A computer-executable program that causes a computer to perform the following:
storing moving image data that includes at least a first frame and a second frame;
detecting a degree of clearness of an image included in a frame of the stored moving image data;
comparing a first image included in the first frame with a second image included in the second frame according to the detected degree of clearness;
selecting a frame having a clearer image, from among the first frame and the second frame, according to a result of the comparison; and
extracting the frame selected by the selection as still image data.

20. A computer-readable storage medium storing a program that causes a computer to perform the following:
storing moving image data that includes at least a first frame and a second frame;
detecting a degree of clearness of an image included in a frame of the stored moving image data;
comparing a first image included in the first frame with a second image included in the second frame according to the detected degree of clearness;
selecting a frame having a clearer image, from among the first frame and the second frame, according to a result of the comparison; and
extracting the frame selected by the selection as still image data.
